(19) United States
(12) Patent Application Publication
(10) Pub. No.: US 2025/0290610 A1
(43) Pub. Date: Sep. 18, 2025

(54) Solar Powered Light

(71) Applicant: CARL MARATTA, WETHERSFIELD, CT (US)

(72) Inventor: CARL MARATTA, WETHERSFIELD, CT (US)

(21) Appl. No.: 18/607,577

(22) Filed: Mar. 18, 2024

(51) Int. Cl. F21V 23/00; F21V 21/08; F21Y 115/10; H02S 30/10

(52) U.S. Cl. CPC F21S 9/037; F21S 8/086; F21V 21/08; H02S 30/10; F21Y 2115/10

(57) ABSTRACT

A modular solar cell assembly including a first mounting member having first and second opposed sides, each of the opposed sides including at least one appendage. Embodiments may include first and second modular members each having first and second sides that are respectively solar cells and LED lighting. Embodiments may include a first mounting member having first and second opposed sides, each of the opposed sides may include at least one appendage; first and second modular members each have first and second sides, each of said first sides having solar cells and each of the second sides including LED lighting. Each of the first and second modular members are selectively attachable respectively to an appendage on respective first and second opposed sides of the first mounting member.

### PRIOR ART

The present invention is generally directed to lighting. More particularly, the present invention is directed to modular solar powered lighting system. Even more particularly, the present invention is directed to solar powered lighting that provides a modular construction to facilitate installation and use.

### BACKGROUND OF THE INVENTION

A wide variety of solar powered lighting apparatus is known. Despite the wide variety it is difficult to find an optimum apparatus for many lighting requirements.

Accordingly, it is therefore seen that there exists a need in the art to overcome the deficiencies and limitations described herein and above.

### SUMMARY OF THE INVENTION

The shortcomings of the prior art are overcome and additional advantages are provided in a modular solar cell assembly including a first mounting member having first and second opposed sides, each of the opposed sides including at least one appendage. Embodiments may include first and second modular members each having first and second sides that are respectively solar cells and LED lighting, each of the first sides having solar cells and each of modular solar cell assembly.

Embodiments may include a first mounting member having first and second opposed sides, each of the opposed sides may include at least one appendage; first and second modular members each having first and second sides, each of the first sides having solar cells and each of the second sides include LED lighting. Each of the first and second modular members are selectively attachable respectively to an appendage on the respective first and second opposed sides of the first mounting member.

Additional features and advantages are realized through the techniques of the present invention. Other embodiments and aspects of the invention are described in detail herein and are considered a part of the claimed invention.

### BRIEF DESCRIPTION OF DRAWINGS

The subject matter which is regarded as the invention is particularly pointed out and distinctly claimed in the concluding portion of the specification. Although specific features of various exemplary embodiments of the invention may be shown in some drawings and not in others, this is for convenience only. In accordance with the principles of the invention, any feature of a drawing maybe referenced and/or claimed in combination with any feature of any other drawing.

The invention, however, both as to organization and method of practice, together with the further objects and advantages thereof, may best be understood by reference to the following description taken in connection with the accompanying drawings in:

FIG. 1 is a top view of an assembly of a mounting module together with two identical lighting module assemblies illustrating the top solar cell surfaces of the lighting assemblies,

FIG. 2 is a bottom view of an assembly of the modular mounting module together with two identical lighting module is assemblies illustrating the bottom LED lighting side of the lighting assemblies, and

FIG. 3 is a side view of an assembly shown in FIGS. 1 and 2,

FIG. 4A is a bottom view of an individual lighting module assembly

FIG. 4B is a bottom view of the mounting module,

FIG. 4C is a top view of an individual lighting module assembly.

FIG. 5 is an isometric view illustrating the mounting of a mounting module and two identical lighting modules at the upper axial extremity of a post.

FIG. 6 is an isometric view illustrating the mounting of a mounting module and two identical lighting modules on a horizontal part of sign post.

FIG. 7 is another isometric view illustrating the mounting of a lighting module directly to the side of a horizontal part of a sign post.

### DETAILED DESCRIPTION OF THE INVENTION

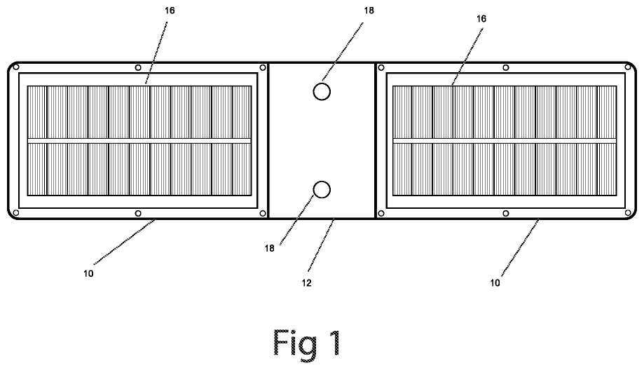

Referring now to FIG. 1 there is shown two identical lighting modules 10 coupled to a mounting module 12. The mounting module 12 is provided with holes 18 for mounting the mounting module 12. The upper face of the lighting modules 10 illustrated in this figure include respective solar cells assemblies 16.

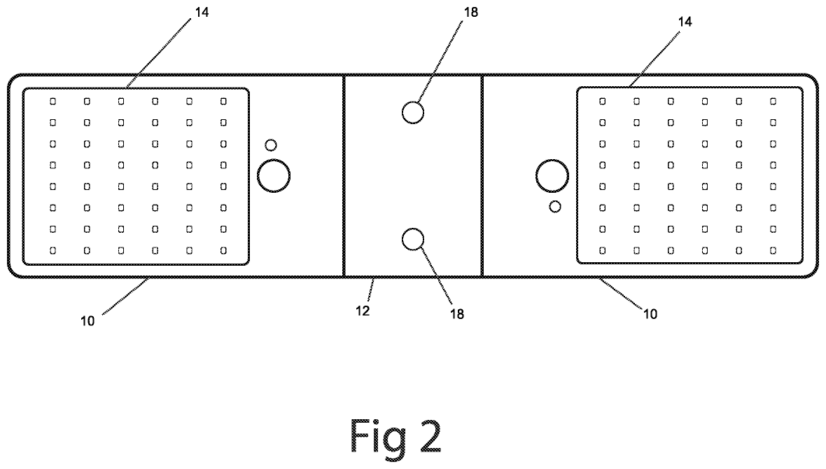

FIG. 2 illustrates the reverse side of the apparatus illustrated in FIG. 1 and also illustrates an LED assembly 14 on each lighting module 10.

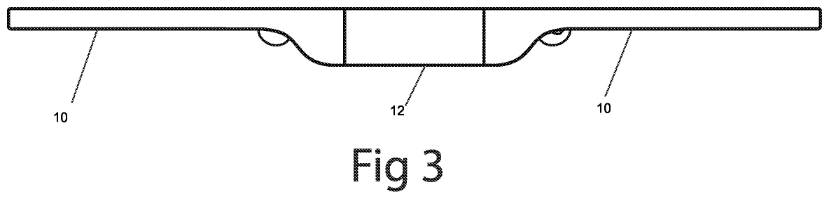

FIG. 3 is a side view of the same assembly

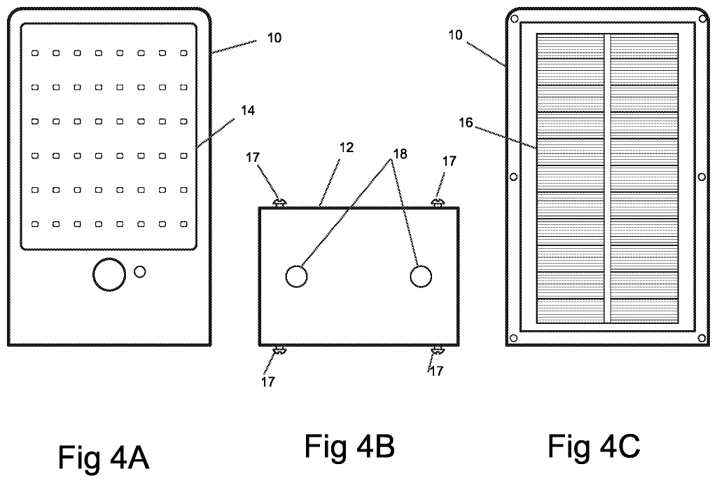

FIG. 4A is a bottom view of a lighting module 10 having LED lighting 14.

FIG. 4B is a top view of the mounting module 12 illustrating screws heads 17 extending from the mounting module 12 to for engagement with respective lighting modules 10.

FIG. 4C is a bottom view of a lighting mounting module 10 illustrating solar cells 16.

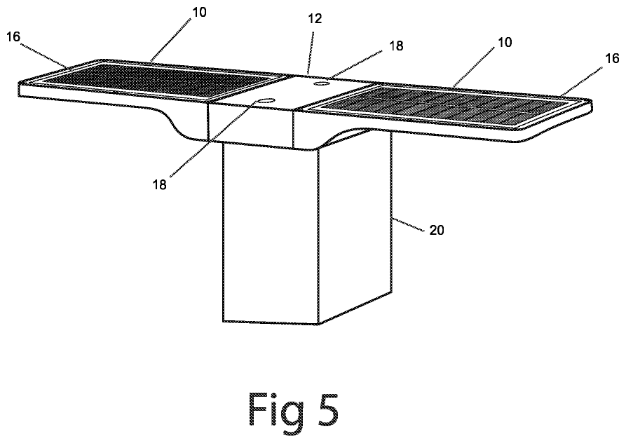

FIG. 5 illustrates the mounting of an assembly of two lighting modules 10 and a mounting module 12 on the axial extremity of a post or column 20.

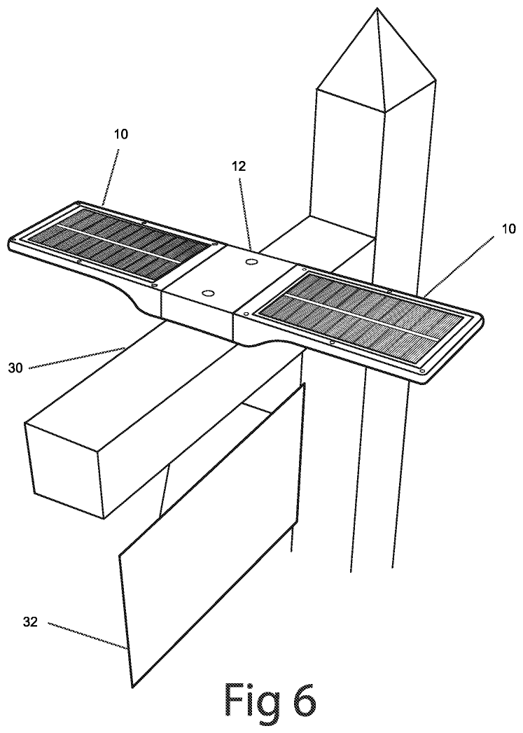

FIG. 6 illustrates the mounting of an assembly of two lighting modules 10 and a mounting module 12 on a horizontal support 20. Accordingly, this figure illustrates the illumination and of both sides of a single sign by one form of the present apparatus.

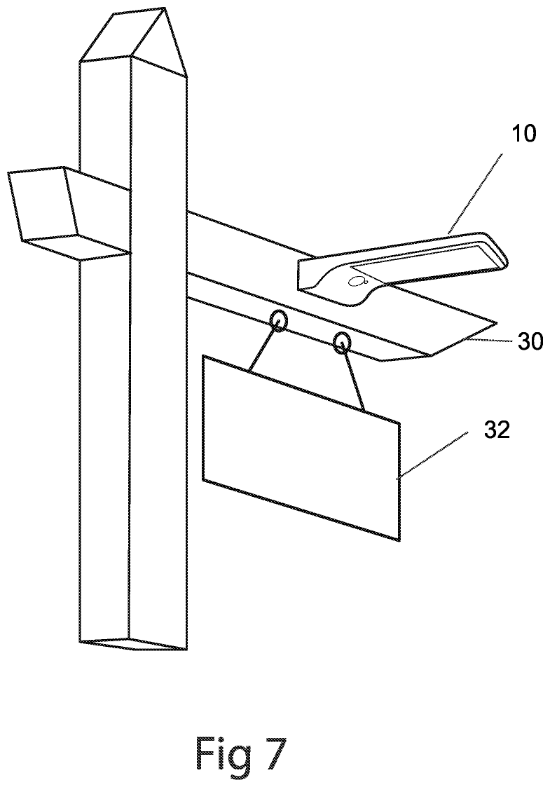

FIG. 7 illustrates an example of the use of two screws (not shown) in the side of a horizontal member to engage the lighting module 10. It will be understood that two screws in the side of the horizontal member 30 correspond to the two screws in the side of the mounting block 12.

All publications and patent applications mentioned in this specification are indicative of the level of skill of those skilled in the art to which this invention pertains. All publications and patent applications are herein incorporated by reference to the same extent as if each individual publication or patent application was specifically and individually indicated to be incorporated by reference.

It will be understood that, in general, terms used herein, and especially in the appended claims, are generally intended as “open” terms (e.g., the term “including” should be interpreted as “including but not limited to,” the term “having” should be interpreted as “having at least,” the term “includes” should be interpreted as “includes but is not limited to,” etc.). It will be further understood that if a specific number of an introduced claim recitation is intended such an intent will be explicitly recited in the claim, and in the absence of such recitation no such intent is present. For example, as an aid to understanding, the following appended claims may contain usage of introductory phrases such as “at least one” or “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “an imager” should typically be interpreted to mean “at least one imager”); the same holds true for the use of definite articles used to introduce claim recitations. In addition, even if a specific number of an introduced claim recitation is explicitly recited, it will be recognized that such recitation should typically be interpreted to mean at least the recited number (e.g., the bare recitation of “two images,” or “a plurality of images,” without other modifiers, typically means at least two images).

Furthermore, in those instances where a phrase such as “at least one of A, B, and C,” “at least one of A, B, or C,” or “an [item] selected from the group consisting of A, B, and C,” is used, in general such a construction is intended to be disjunctive (e.g., any of these phrases would include but not be limited to systems that have A alone, B alone, C alone, A and B together, A and C together, B and C together, or A, B, and C together, and may further include more than one of A, B, or C, such as A₁, A₂, and C together, A, B₁, B, C₁, and C₂ together, or B₁ and B₂ together). It will be further understood that virtually any disjunctive word or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

Although the description above contains many specifics, these should not be construed as limiting the scope of the invention, but as merely providing illustrations of some of the presently preferred embodiments of this invention. Thus, the scope of this invention should be determined by the appended claims and their legal equivalents. Therefore, it will be appreciated that the scope of the present invention fully encompasses other embodiments which may become obvious to those skilled in the art, and that the scope of the present invention is accordingly to be limited by the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A modular solar cell apparatus comprising:
a first mounting member having first and second planar opposed parallel sides, each of said planar opposed sides including at least one appendage, each of said appendages being at least one screw head having an enlarged head;
first and second modular lighting members each having first and second planar sides, each of said first sides having solar cells and each of said second sides including LED lighting;
each said first and second modular lighting members being selectively attachable respectively to said enlarged extremity one of said appendages on respective first and second opposed sides of said first mounting member.

2.-3. (canceled)

4. The apparatus as described in claim 1 wherein each of said first sides having solar cells of said first and second modular members are coplanar and face upward after installation.
